(19) United States
(12) Patent Application Publication
(10) Pub. No.: US 2011/0045328 A1
(43) Pub. Date: Feb. 24, 2011

(54) NON-AQUEOUS ELECTROLYTE BATTERY AND BATTERY PACK

(76) Inventors: Hiroki Inagaki, Kawasaki-shi (JP); Yasuhiro Harada, Yokohama-shi (JP); Keigo Hoshina, Yokohama-shi (JP); Norio Takami, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/850,160

(22) Filed: Aug. 4, 2010

(30) Foreign Application Priority Data
Aug. 20, 2009 (JP) 2009-191262

(51) Int. Cl. H01M 2/02; H01M 10/48

(52) U.S. Cl. 429/90; 429/163; 429/159

(57) ABSTRACT

According to one embodiment, a non-aqueous electrolyte battery includes an outer case, a positive electrode housed in the outer case and containing a positive electrode active material, a negative electrode housed in the outer case and containing a monoclinic crystal β-type titanium composite oxide, and a non-aqueous electrolyte filled in the outer case. An absolute value of a gradient of a potential of the negative electrode is larger than that of the positive electrode. Wherein, each of the gradients of a potential of the negative and positive electrodes is found from variations in potential which come at the state of full charge on an open-circuit potential curve drawn from potentials of the positive electrode and the negative electrode.

### CROSS-REFERENCE TO RELATED APPLICATIONS

This application is based upon and claims the benefit of priority from Japanese Patent Application No. 2009-191262, filed Aug. 20, 2009; the entire contents of which are incorporated herein by reference.

### FIELD

Embodiments described herein relate generally to a non-aqueous electrolyte battery and a battery pack comprising a plurality of non-aqueous electrolyte batteries.

### BACKGROUND

Enthusiastic research and development are being made on non-aqueous electrolyte batteries which are charged and discharged by the movement of lithium ions between the negative electrode and the positive electrode as high-energy density batteries. These non-aqueous electrolyte batteries desirably have various characteristics corresponding to their uses. These batteries desirably have superior cycle characteristics under a high-temperature environment when they are used in automobile applications for use in hybrid electronic vehicles and in emergencies for electronic devices. In usual non-aqueous electrolyte batteries, at present, the positive electrode active material is a lithium-transition metal composite oxide and the negative electrode active material is a carbonaceous material.

### BRIEF DESCRIPTION OF THE DRAWINGS

FIG. 1 is a typical sectional view showing an example of a non-aqueous electrolyte battery according to an embodiment;

FIG. 2 is an enlarged sectional view of the A part of FIG. 1;

FIG. 3 is a partially broken perspective view typically showing another non-aqueous electrolyte battery according to an embodiment;

FIG. 4 is an enlarged sectional view of the B part of FIG. 3;

FIG. 5 is a perspective view showing an electrode group having a laminate structure which is used in a non-aqueous electrolyte battery according to an embodiment;

FIG. 6 is an exploded perspective view of a battery pack according to an embodiment;

FIG. 7 is a block diagram showing an electric circuit of a battery pack according to an embodiment;

FIG. 8 is a typical view showing a series hybrid vehicle according to an embodiment;

FIG. 9 is a typical view showing a parallel hybrid vehicle according to an embodiment;

FIG. 10 is a typical view showing a series-parallel hybrid vehicle according to an embodiment;

FIG. 11 is a typical view showing a vehicle according to an embodiment;

FIG. 12 is a typical view showing a hybrid motorcycle according to an embodiment;

FIG. 13 is a typical view showing an electric motorcycle according to an embodiment;

FIG. 14 is a view showing the potential gradients of a negative electrode and a positive electrode, wherein each of the gradients of a potential of the negative and positive electrodes is found from variations in potential which come at the state of full charge on an open-circuit potential (OCP) curves of the positive electrode and the negative electrode; and

FIG. 15 is a charging curve (when inserting lithium) when the counter electrode of a typical monoclinic crystal β-type titanium composite oxide (TiO₂ (B)) is lithium.

### DETAILED DESCRIPTION

In general, according to one embodiment, a non-aqueous electrolyte battery includes: an outer case; a positive electrode housed in the outer case and comprising a positive electrode active material; a negative electrode housed in the outer case and comprising a monoclinic crystal β-type titanium composite oxide; and a non-aqueous electrolyte filled in the outer case. In the non-aqueous electrolyte battery, an absolute value of a gradient of a potential of the negative electrode is larger than that of the positive electrode, wherein each of the gradients of a potential of the negative and positive electrodes is found from variations in potential which come at the state of full charge on an open-circuit potential curve drawn from potentials of the positive electrode and the negative electrode.

A non-aqueous electrolyte battery comprising a negative electrode containing carbon as the active material is so designed that the capacity of the negative electrode is larger than that of the positive electrode. This is to suppress the precipitation of a lithium metal on the negative electrode, which may decrease the performance.

When the same design is applied to a non-aqueous electrolyte battery using a monoclinic β-type titanium composite oxide as the negative electrode active material and a lithium transition metal composite oxide as the positive electrode active material, on the other hand, the battery is decreased in cycle characteristics. Also, the performance at the time of overcharge is further decreased.

Specifically, in a non-aqueous electrolyte battery which is so designed that the capacity of the negative electrode is larger than that of the positive electrode, when comparing the potential gradient of a negative electrode with the potential gradient of a positive electrode, wherein each of the potential gradients of the negative and positive electrodes is found from variations in potential which come at the state of full charge on an open-circuit potential curve drawn from each potentials of the positive electrode and the negative electrode, the absolute value of the potential gradient of the positive electrode is larger than that of the negative electrode. If such a battery is overcharged, the potential of the negative electrode follows the gradient of the potential of the positive electrode, so that a drop in the potential of the negative electrode is reduced and a rise in the potential of the positive electrode is predominant.

A monoclinic β-type titanium composite oxide has high structural stability in an overcharged state and is therefore resistant to overcharge cycle deterioration. On the contrary, positive electrode active materials typified by a layer compound of LiNiO₂ and Li(Ni, Co, Mn) O₂ have inferior structural stability under an overcharged state. This brings about a structural change, leading to a significant reduction in overcharge cycle characteristics if a rise in the potential of the positive electrode is dominant when the battery is overcharged.

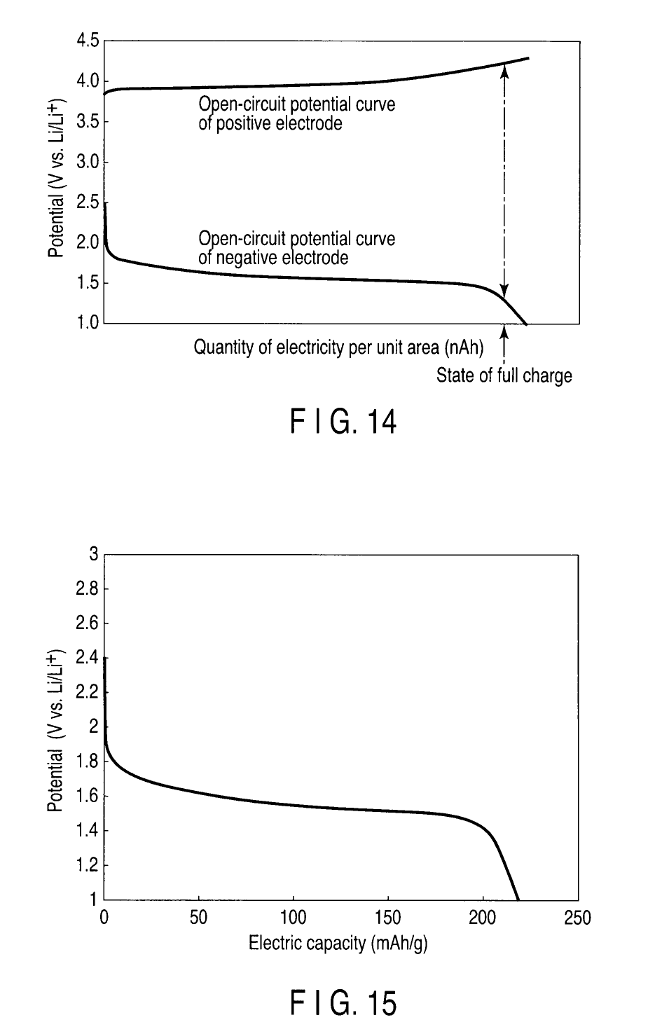

From this point of view, the absolute value of the potential gradient of the negative electrode is made larger than that of the positive electrode, as shown in FIG. 14, wherein each of the gradients of a potential of the negative and positive electrodes is found from variations in potential which come at the state of full charge on an open-circuit potential curve drawn from potentials of the positive electrode and the negative electrode. This contributes to a reduction in the rise of the potential of the positive electrode along with the magnitude of the gradient of the potential of the negative electrode and a drop in the potential of the negative electrode is predominant when the battery is put in an overcharged state. As mentioned above, a monoclinic β-type titanium composite oxide as the negative electrode active material has high structural stability even in an overcharged state and is resistant to overcharge cycle deterioration, and therefore, the overcharge cycle performance can be improved. At the same time, the safety against overcharging can also be improved.

The OCP curve can be found by the following method. A battery put into a discharge state is disintegrated promptly in an inert gas atmosphere, such as an argon atmosphere, to cut out the negative electrode and positive electrode from the center of the electrode group such that both electrodes have the same area (for example, 20 mm×20 mm). When the active material layer is applied to each surface of the current collector in the cut electrode, the active material layer on one of these surfaces is peeled off and the resulting cut electrode is used as an electrode for measurement. Metal lithium is used as a reference electrode and a glass filter (or a polyethylene porous film) is used as a separator. As the electrolyte, a non-aqueous electrolyte solution obtained by dissolving 1 M LiPF₆ in a mixed solvent of ethylene carbonate and diethylcarbonate (volume ratio: 1:2) is used. The cut negative and positive electrodes are overlapped on each other through the separator such that the active material layers of these electrodes are disposed opposite to each other and the reference electrode (metal lithium) is disposed to fabricate a triple-pole type glass cell. The non-aqueous electrolyte solution is made to sufficiently penetrate into the separator and the electrodes by, for example, vacuum impregnation. The battery is charged at a constant current (for example, 0.1 C) for a fixed time (for example, 5% of the electrode capacity) and is allowed to stand for 6 hours after being charged to measure the open-circuit potential (OCP). These operations are conducted in an environment of a temperature of 25° C. The OCP curve can be obtained by repeating this operation. The potential is measured in increments of 1% of the capacity of the electrode in the last stage of the process of fully charging the battery.

Here, the term “1 C” means the current value required terminating a discharge of a battery in one hour and the value of the rated capacity of the battery may be replaced with the 1 C current value for the sake of convenience. Therefore, 0.1 C means a current value required until the rated capacity is terminated the discharge in 10 hours.

The term “the state of full charge” has the same meaning as the term “perfect charge” described and defined in “Evaluation of Safety of Lithium Secondary Battery, Standard Guideline” (SBA 61101-1997) which is one of the guidelines established by BATTERY ASSOCIATION OF JAPAN. In other words, the term “the state of full charge” indicates the state of the battery charged using the charge method, standard charge method or recommended charge method which is used to find the rated capacity of each battery.

The term “come at the state of full charge” means a process in which the capacities of the positive electrode and negative electrode respectively reach 99% to 100% when the capacities of the positive electrode and negative electrode put in the state of full charge are respectively set to 100%.

A non-aqueous electrolyte battery comprising a negative electrode containing a monoclinic β-type titanium composite oxide as an active material is so designed that the open-circuit potential of the negative electrode at which the negative electrode is the state of full charge is 1.48 V vs Li/Li⁺ or less. This ensures that the overcharge cycle performance can be significantly improved and also, the safety against overcharging can be outstandingly improved at the same time.

Specifically, as shown in FIG. 15, the open-circuit potential of the monoclinic β-type titanium composite oxide is gradually dropped in the range of 2 V to 1.5 V vs Li/Li⁺ and sharply dropped from 1.5 V vs Li/Li⁺ in the course of a lithium ion insertion reaction (charge process).

A battery so designed that the open-circuit potential of the negative electrode in the state of full charge is in the range of 1.48 V vs Li/Li⁺ or less means that the absolute value of the gradient of the potential of the negative electrode, wherein each of the gradients of a potential of the negative and positive electrodes is found from variations in potential which come at the state of full charge on an open-circuit potential (OCP) curve drawn from each potentials of the positive electrode and the negative electrode, is steep, that is, very large as shown in FIG. 15. For this reason, the absolute value of the gradient of the potential of the negative electrode can be made significantly larger than the absolute value of the gradient of the potential of the positive electrode. As a result, if the battery is overcharged, the potential of the positive electrode follows the magnitude of the gradient of the potential of the negative electrode, so that a rise in the potential of the positive electrode is reduced and a drop in the potential of the negative electrode is predominant. As mentioned above, the monoclinic β-type titanium composite oxide which is the negative electrode active material also has high structural stability in an overcharged state and is resistant to overcharge cycle deterioration, making it possible to outstandingly improve the overcharge cycle characteristics. At the same time, the safety against overcharging can be outstandingly improved. The open-circuit potential of the negative electrode at which the negative electrode is the state of full charge is more preferably 1.40 V vs Li/Li⁺ or less.

Such a battery comprising the negative electrode having the larger absolute value of the gradient and the OCP of the range can be attained by controlling the electric capacity per unit area of each of the positive and negative electrodes. The controlling the electric capacity per unit area is carried out by regulating the coating amount of the positive and negative electrodes based on a result by measuring the electric capacity per unit area of each of the positive and negative electrodes.

For example, the following design is possible in the case of using TiO₂ (B) as the negative electrode and LiCoO₂ as the positive electrode.

The positive electrode and negative electrode which are respectively applied only to one surface are punched into a predetermined size (for example, 2×2 cm) and a lithium metal is used for the counter electrode and reference electrode to manufacture a glass cell. This glass cell is used to find the electric capacity per unit area of the positive electrode or negative electrode in an environment of 25° C.

The negative electrode TiO₂ (B) is charged under a constant current of 0.1 C and a constant voltage of 1.0 V for 24 hours to find its electric capacity. The positive electrode LiCoO₂ is charged under a constant current of 0.1 C and a constant voltage of 4.3 V for 24 hours to find its electric capacity.

Based on the coating amount in which the ratio of the electric capacities per unit area is 1:1, any one of these coating amounts is fixed and the other is changed, thereby making it possible to control the open-circuit potential of the negative electrode.

In this case, a proper charge potential is selected for the positive electrode from the viewpoint of charge-discharge reversibility and safety. For this reason, it is preferable to select the charge potential according to the type of the positive electrode active material.

The outer case, negative electrode, positive electrode, non-aqueous electrolyte and separator, which are the structural members of the non-aqueous electrolyte battery, will be explained in detail.

1) Outer case

The outer case is made from a laminate film having a thickness of 0.5 mm or less. Also, a metal container having a thickness of 1.0 mm or less is used for the outer case. The metal container preferably has a thickness of 0.5 mm or less.

Examples of the shape of the outer case include a flat type (thin type), angular type, cylinder type, coin type and button type. Examples of the outer case include outer cases for small-sized batteries to be mounted on portable electronic devices and outer cases for large-sized batteries to be mounted on, for example, two- to four-wheel vehicles.

As the laminate film, a multilayer film obtained by interposing a metal layer between resin layers is used. The metal layer is preferably an aluminum foil or aluminum alloy foil in view of light-weight characteristics. Polymer materials such as polypropylene (PP), polyethylene (PE), nylon and polyethylene terephthalate (PET) may be used for the resin layer. The laminate film can be molded into the shape of the outer case with sealing by thermal fusion.

The metal container is constituted of aluminum or an aluminum alloy. The aluminum alloy is preferably an alloy containing elements such as magnesium, zinc and silicon. When transition metals such as iron, copper, nickel and chromium are contained in the alloy, the amount of these transition metals is preferably designed to be 100 mass-ppm or less.

2) Negative Electrode

The negative electrode comprises a current collector and a negative electrode layer which is formed on one or both surfaces of this current collector and contains an active material, a conductive agent and a binder.

The above active material contains a monoclinic β-type titanium composite oxide. The monoclinic β-type titanium composite oxide is called TiO₂ (B), and is represented by the compositional formula LiₓTiO₂ (x is a value which is varied by a charge-discharge reaction and is in the range of 0≦x≦1).

The monoclinic β-type titanium composite oxide preferably has high crystallinity. The higher the crystallinity of the monoclinic β-type titanium composite oxide contained in the negative electrode, the sharper the absolute value of the gradient of the negative electrode potential is 1.48 V vs Li/Li⁺ or less. The gradient of a potential of the negative electrode is found from variations in potential which come at the state of full charge on an open-circuit potential (OCP) curve drawn from potentials of the negative electrode. Therefore, the aforementioned overcharge cycle performance can be further improved. At the same time, safety against overcharging can also be further improved. The level of crystallinity may be represented by the crystallite diameter, which is calculated from a main peak observed at an angle (2θ) of 48 to 49 degrees when measured by wide-angle X-ray diffraction. The crystallite diameter is preferably 20 nm or more. The crystallite diameter can be calculated by the following method.

A powder (sample) obtained by milling the monoclinic β-type titanium composite oxide is filled in a 0.2 mm deep holder formed in a glass sample plate. The surface of the sample filled in the glass sample plate is smoothed by pressing a separate glass plate against the sample under a pressure of several tens to several hundred MPa from above by hand. At this time, special care must be taken to fill the sample sufficiently in the holder and to avoid a lack (cracks and voids) in the amount of the sample to be filled. The sample is filled into the holder in the same level (0.2 mm) as the top of the holder to take care to prevent any rise and dent from the basic plane of the glass holder.

The following method is more preferably adopted to exclude any displacement in position of diffraction ray peaks and variation in ratio of intensities that are caused by incorrectly filling the powder into the glass sample plate. Specifically, a pressure of about 250 MPa is applied to the above sample for 15 minutes to manufacture a pressured powder pellet having a diameter of 10 mm and a thickness of about 2 mm, and the surface of the pellet is measured.

The measurement using the wide-angle X-ray diffraction method is as follows.

<Measuring Method>

The sample is filled in a standard glass holder having a diameter of 25 mm and measured by the wide-angle X-ray diffraction method. A measuring device and conditions are shown below. The measurement is made in air at ambient temperature (18 to 25° C.).

(1) X-ray diffraction device: trade name: D8 ADVANCE (seal tube type) manufactured by Bruker AXS.

X-ray source: CuKα rays (using a Ni filter)

Output: 40 kV, 40 mA

Slit system: Div. Slit; 0.3 degrees

Detector: LynxEye (high-speed detector)

(2) Scan system: 2θ/θ continuous scan

(3) Range of measurement (2θ): 5 to 100 degrees

(4) Step width (2θ): 0.01712 degrees

(5) Counting time: One second/step

<Analysis, Calculation of a Crystallite Size>

The crystallite diameter (crystallite size) can be calculated by using the Sherrer equation shown below from the half-value width of a peak present at an angle 2θ of 48 to 49 degrees based on the X-ray diffraction pattern of such a monoclinic β-type titanium composite oxide, which pattern is obtained by the wide-angle X-ray diffraction method.

$$Crystallite size ( nm ) = \frac{K λ}{β cos θ}$$

$$β = \sqrt{{β}_{e}^{2} - {β}_{0}^{2}}$$

Here, K=0.9, λ(=0.15406 nm), βₑ: Half value width of the diffraction peak, β₀: Correction value of the half value width (0.07 degrees).

As to the analysis of the negative electrode (uncharged state) before the fabrication of a battery processed (coating and rolling) to form electrodes, the surface of the negative electrode is measured in the above manner, thereby making it possible to calculate the crystallite diameter of the monoclinic β-type titanium composite oxide by the same procedures.

In the case of the negative electrode of a completed battery, on the other hand, the crystallite diameter can be calculated in the following procedures. Specifically, the completed battery is discharged to the rated terminal voltage under 0.1 C current in an environment of 25° C. The discharged battery is disintegrated in an inert gas atmosphere or in the atmosphere to cut out the negative electrode from the center of the electrode group. The cut negative electrode is thoroughly washed with ethylmethyl carbonate to remove the components of the non-aqueous electrolyte. Then, the negative electrode is allowed to stand for one day (or washed with water) to deactivate the negative electrode. The negative electrode in this condition is measured in the same manner as above to calculate the crystallite diameter of the monoclinic β-type titanium composite oxide.

The monoclinic β-type titanium composite oxide preferably has an average primary particle diameter of 1 μm or less. The negative electrode containing such a monoclinic β-type titanium composite oxide is changed sharply in voltage at a voltage of 1.5 V vs Li/Li⁺ or less, and therefore, the aforementioned overcharge cycle performance can be more improved, and at the same time, the safety against overcharging can be more improved. In this case, if the average primary particle diameter is too small, it is difficult to improve crystallinity and a variation in voltage at a voltage of 1.5 V vs Li/Li⁺ or less tends to be less steep. For this reason, the lower limit of the average primary particle diameter is preferably designed to be 20 nm.

The average primary particle diameter of the monoclinic β-type titanium composite oxide can be found by the following manner. The above composite oxide is observed by a transmission electron microscope (TEM) to measure the diameters of 20 primary particles at random in the images taken at random places, and then, an average of these diameters is calculated as the average primary particle diameter. In the case where these primary particles are not isotropic, an average of the major axis and minor axis is defined as a primary particle diameter.

The particle diameter (secondary particle diameter) of the monoclinic β-type titanium composite oxide is measured by using, for example, a laser diffraction type distribution measuring device (trade name: SALD-300, manufactured by Shimadzu Corporation). First, about 0.1 g of the sample, a surfactant and 1 to 2 mL of distilled water are put in a beaker, thoroughly stirred and poured into a stirring water tank. The distribution of luminosity may be measured 64 times at intervals of 2 seconds to analyze the obtained data of the grain distribution, thereby finding an average particle diameter (secondary particle diameter).

The monoclinic β-type titanium composite oxide preferably has a specific surface area of 5 to 100 m²/g. The negative electrode containing such a monoclinic β-type titanium composite oxide is superior in large-current performance.

The specific surface area is measured using a method in which molecules whose adsorption occupied area is known are allowed to adsorb to the surface of powder particles at the temperature of liquid nitrogen to find the specific surface area of the sample from the amount of the adsorbed molecules. In this method, the BET method based on low-temperature and low-humidity physical adsorption of inert gas is most used. This method is based on the well known theory that is developed by extending the Langmuir theory, which is the monolayer adsorption theory, to multilayer adsorption, and is used as the method of calculating specific surface area. The specific surface area found by this method is called “BET specific surface area”, or more simply “specific surface area”.

The conductive agent serves to improve the current-collecting performance of the active material and to reduce the contact resistance with the current collector. Examples of the conductive agent include acetylene black, carbon black and graphite.

The binder binds the active material with the conductive agent. Examples of the binder include polytetrafluoroethylene (PTFE), polyvinylidene fluoride (PVdF), fluoro-rubber and styrene-butadiene rubber.

The active material, conductive agent and binder contained in the negative electrode layer are preferably formulated in a ratio of 70% by weight or more and 96% by weight or less, 2% by weight or more and 28% by weight or less and 2% by weight or more and 28% by weight or less, respectively. When the amount of the conductive agent is less than 2% by weight, the current collecting performance of the negative electrode layer is decreased and there is therefore a fear as to decrease in large-current characteristics of the non-aqueous electrolyte battery. Also, when the amount of the binder is less than 2% by weight, the binding ability between the negative electrode layer and the current collector is decreased and there is therefore a fear as to decreased cycle characteristics. On the other hand, the amounts of the conductive agent and binder are respectively preferably 28% by weight or less in view of attaining a high capacity.

The current collector is preferably made of an aluminum foil or an aluminum alloy foil containing elements such as Mg, Ti, Zn, Mn, Fe, Cu and Si, which is electrochemically stable in a potential range higher than 1.0 V vs Li/Li⁺.

The average crystal particle diameter of an aluminum foil or aluminum alloy foil is preferably 50 μm or less. Because such a current collector can increase the strength outstandingly, the negative electrode can be highly densified under a high pressure, making it possible to increase the capacity of the battery. Also, because the dissolution/corrosive deterioration of the current collector in an overcharge cycle under a high-temperature environment (40° C. or more) can be prevented, a rise in negative electrode impedance can be suppressed. Moreover, the output characteristics, high-speed charge and charge-discharge cycle characteristics can also be improved. The average crystal particle diameter is more preferably 30 μm or less and even more preferably 5 μm or less.

The average crystal particle diameter may be found by the following method. The tissue of the surface of the current collector is observed by an optical microscope to find the number n of crystal particles present in an area of 1 mm×1 mm. Using this number n, an average crystal particle area S is calculated from the equation: S=1×10⁶/n (μm²). Then, an average particle diameter d (μm) is calculated from the obtained value of S by the following equation.

d=2(S/n)^{1/2}

The thickness of the aluminum foil or aluminum alloy foil is preferably 20 μm or less and more preferably 15 μm or less.

The negative electrode may be manufactured by the following method. For example, the active material, conductive agent and binder are suspended in a usual solvent to prepare a slurry. This slurry is applied to the current collector and dried to form a negative electrode layer. Then, the negative electrode layer is pressed to manufacture a negative electrode. Also, the negative electrode may be manufactured by making the active material, conductive agent and binder into a pellet-like form to thereby produce a negative electrode layer, which is then formed on the current collector.

3) Positive Electrode

The positive electrode comprises a current collector and a positive electrode layer which is formed on one or both surfaces of the current collector and contains an active material, a conductive agent and a binder.

As the active material, for example, oxides or polymers may be used.

Examples of the oxide include manganese dioxide (MnO₂) with lithium inserted thereinto, iron oxide, copper oxide, nickel oxide, lithium-manganese composite oxide (for example, LiₓMn₂O₄ or LiₓMnO₂), lithium-nickel composite oxide (for example, LiₓNiO₂), lithium-cobalt composite oxide (LiₓCoO₂), lithium-nickel-cobalt composite oxide (for example, LiNi_{1-y}CO_{y}O₂), lithium-manganese-cobalt composite oxide (for example, LiₓMn_{y}CO_{1-y}O₂), spinel type lithium-manganese-nickel composite oxide (LiₓMn_{2-y}Ni_{y}O₄), lithium-phosphorous oxide having an olivine structure (for example, LiₓFePO₄, LiₓFe_{1-y}Mn_{y}PO₄ or LiₓCoPO₄), iron sulfate (Fe₂(SO₄)₃) and vanadium oxide (for example, V₂O₅). Here, x and y preferably satisfy 0<x≦1 and 0≦y≦1.

Examples of the polymer include conductive polymer materials such as polyaniline and polypyrrole and disulfide-based polymers. Sulfur and fluorocarbon may also be used as the active material.

Preferable examples of the active material include materials having a higher positive electrode voltage, for example, lithium-manganese composite oxide (LiₓMn₂O₄), lithium-nickel composite oxide (LiₓNiO₂), lithium-cobalt composite oxide (LiₓCoO₂), lithium-nickel-cobalt composite oxide (LiₓNi_{1-y}Co_{y}O₂), spinel type lithium-manganese-nickel composite oxide (LiₓMn_{2-y}Ni_{y}O₄), lithium-manganese-cobalt composite oxide (LiₓMn_{y}CO_{1-y}O₂) and lithium-iron phosphate (LiₓFePO₄). Here, x and y preferably satisfy 0<x≦1 and 0≦y≦1.

When the active material is, for example, an oxide having a layer crystal structure (hereinafter referred to as a layer oxide) such as LiₓCoO₂, LiₓNiO₂ or Liₓ(Ni, Co or Mn)O₂, a higher effect can be obtained.

Specifically, in the case of spinel type compounds typified by LiₓMn₂O₄, charge and discharge are repeated in the range of x: 0≦x≦1 and these compounds are structurally stable in this range. Even in the case where the positive electrode containing a spinel type compound is charged to an overcharge potential, the molar ratio of lithium does not take a value less than 0 and the structure of the positive electrode is kept stable. For this reason, the spinel type compound is originally decreased in charge-discharge cycle deterioration when the electrode is overcharged. This is the same for olivine compounds typified by LiₓFePO₄. However, if the positive electrode is exposed to a high potential, oxidation decomposition with the non-aqueous electrolyte is accelerated, which accelerates the growth of a coating film which is a cause of deteriorated resistance. For this reason, even in the case of using such a positive electrode active material, the effect of the embodiment, that is, the overcharge cycle characteristics can be improved. At the same time, the safety against overcharging can also be improved.

LiₓCoO₂, a typical layer compound, absorbs lithium within the range of 0≦x≦0.45. Namely, when this compound is charged, its crystal structure is destroyed, bringing about significantly deteriorated reversibility. Therefore, when such a layer oxide is used, it is desirable to control charge and discharge such that x falls in the range of 0.45≦x≦1 to maintain charge-discharge cycle characteristics. When x is less than 0.45, the crystal structure of LiₓCoO₂ is changed in phase from a hexagonal system to a monoclinic system and this change in crystal structure possibly brings about the destruction of the active material particles. On the other hand, it is desirable to charge the electrode until the battery is fully charged, that is, until x=0.45 from the viewpoint of obtaining high capacity. In order to make these properties compatible, it is desirable to control charge and discharge such that x varies between 0.45 and 1. In the non-aqueous electrolyte battery according to the embodiment, the positive electrode is scarcely exposed to an overcharged condition. It is therefore easy to control x, which enables stable cycle performance to be attained.

Similarly, in the case of LiₓNiO₂, lithium is inserted until x is below 0.3. Namely, when charged, this compound is changed in its crystal structure and there is therefore the possibility of the active material particles being destructed. For this reason, it is desirable to control charge and discharge such that x varies between 0.3 and 1. The non-aqueous electrolyte battery according to this embodiment is made to have the aforementioned structure in which the absolute value of the gradient of the potential of the negative electrode can be made larger than that of the positive electrode. Wherein each of the gradients of a potential of the negative and positive electrodes is found from variations in potential which come at the state of full charge on an open-circuit potential curve drawn from potentials of the positive electrode and the negative electrode. As a result, the destruction of the structure of an active material particle can be suppressed efficiently. Moreover, the growth (cause of deteriorated resistance) of a coating film formed by the oxidation decomposition with the non-aqueous electrolyte as mentioned above can be suppressed. For this reason, the effect of the embodiment, that is, the overcharge cycle characteristics can be improved and at the same time, the safety against overcharging can also be improved.

Examples of the layer crystal structure may include a layer rock salt structure. Lithium transition metal oxides having a layer crystal structure are represented by the compositional formula Li_{y}M1_{z1}M2_{z2}O₂. Here, M1 is at least one element selected from the group consisting of Co, Ni and Mn, M2 is at least one element selected from the group consisting of Fe, Al, B, Ga and Nb and y, z1 and z2 satisfy 0<y≦1.2, 0.98≦z1+z2≦1.2 and 0≦z2≦0.2. The ratio of the amount of Ni to the total amount of M1 and M2 is preferably 0.0 or more and 0.85 or less. In this case, M1 may be constituted either only of Ni or of Ni and at least one element selected from the group consisting of Co and Mn.

M1 is selected from Co, Ni and Mn for the reason mentioned above.

M2 is a substitution element for M1 and adequately added according to the characteristics desired for the non-aqueous electrolyte battery. Such a substitution element is preferably at least one element selected from the group consisting of Fe, Al, B, Ga and Nb. Among these elements, Al is preferable because it can reduce the coating resistance at the interface between the positive electrode and the electrolyte and stabilizes the crystal structure.

The layer lithium transition metal oxide in which y, z1 and z2 respectively fall in the above range has more superior cycle characteristics.

The conductive agent serves to improve the current-collecting performance of the active material and to reduce the contact resistance with the current collector. Examples of the conductive agent include carbonaceous materials such as acetylene black, carbon black or graphite.

The binder serves to bind the active material with the conductive agent. Examples of the binder include polytetrafluoroethylene (PTFE), polyvinylidene fluoride (PVdF) or fluoro-rubber.

The active material, conductive agent and binder contained in the positive electrode layer are preferably formulated in a ratio of 80% by weight or more and 95% by weight or less, 3% by weight or more and 18% by weight or less and 2% by weight or more and 17% by weight or less, respectively. When the amount of the conductive agent is 3% by weight or more, the conductive agent can produce the aforementioned effect. When the amount of the conductive agent is 18% by weight or less, the conductive agent can reduce the decomposition of the non-aqueous electrolyte on the surface thereof when stored under a high-temperature condition. When the amount of the binder is 2% by weight or more, sufficient positive electrode strength is obtained. When the amount of the binder is 17% by weight or less, the amount of the binder which is an insulting material in the positive electrode can be reduced, leading to reduced internal resistance.

The current collector is preferably made of an aluminum foil or an aluminum alloy foil containing at least one element selected from Mg, Ti, Zn, Mn, Fe, Cu and Si.

The average crystal particle diameter of an aluminum foil or aluminum alloy foil is preferably 50 μm or less. The average crystal particle diameter is more preferably 30 μm or less and even more preferably 5 μm or less. An aluminum foil or an aluminum alloy foil having an average crystal particle diameter of 50 μm or less can increase the strength outstandingly and can densify the positive electrode by pressing under high pressure, thereby making it possible to increase the capacity of the battery.

The thickness of the aluminum foil or aluminum alloy foil is preferably 20 μm or less and more preferably 15 μm or less.

The positive electrode may be manufactured by the following method. For example, the active material, conductive agent and binder are suspended in a usual solvent to prepare a slurry. This slurry is applied to the current collector and dried. Then, the coating film is subjected to pressing to form a positive electrode. The positive electrode may also be manufactured by forming the active material, conductive agent and binder into a pellet-like material to form a positive electrode layer, which is then formed on the current collector.

4) Non-Aqueous Electrolyte

Examples of the non-aqueous electrolyte include liquid non-aqueous electrolytes prepared by dissolving an electrolyte in an organic solvent and gel-like non-aqueous electrolytes obtained by making a complex of a liquid electrolyte and a polymer material.

The liquid non-aqueous electrolyte is prepared by dissolving an electrolyte in a concentration of 0.5 mol/L or more and 2.5 mol/L or less in an organic solvent.

Examples of the electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethasulfonate (LiCF₃SO₃) and bistrifluoromethylsulfonylimide lithium [LiN(CF₃SO₂)₂] and mixtures of these lithium salts. Bistrifluoromethylsulfonylimide lithium [LiN(CF₃SO₂)₂] is superior in resistance to reduction and stable to water and is hence desirable. It is most preferable to use a combination of this electrolyte and lithium hexafluorophosphate (LiPF₆) or lithium tetrafluoroborate (LiBF₄).

Examples of the organic solvent include cyclic carbonates such as propylene carbonate (PC), ethylene carbonate (EC) and vinylene carbonate (DMC); chain carbonates such as diethyl carbonate (DEC), dimethyl carbonate (DMC) and methyl ethyl carbonate (MEC); cyclic ethers such as tetrahydrofuran (THF), 2-methyltetrahydrofuran (2MeTHF) and dioxolan (DOX); chain ethers such as dimethoxyethane (DME) and diethoethane (DEE); γ-butyrolactone (GBL), acetonitrile (AN) and sulfolane (SL). These organic solvents may be used either singly or in combination of two or more.

Preferable examples of the organic solvent include a mixed solvent obtained by blending at least two or more solvents selected from the group consisting of propylene carbonate (PC), ethylene carbonate (EC) and γ-butyrolactone (GBL). The organic solvent is preferably γ-butyrolactone (GBL), which is superior in resistance to reduction.

Examples of the polymer include polyvinylidene fluoride (PVdF), polyacrylonitrile (PAN) and polyethylene oxide (PEO).

In this case, as the non-aqueous electrolyte, a cold molten salt (ionic molten material) containing lithium ions, polymer solid electrolyte or inorganic solid electrolyte may be used.

The cold molten salts (ionic molten material) mean compounds which can exist as a liquid at normal temperature (15° C. to 25° C.) among organic salts prepared from a combination of organic cations and anions. Examples of the cold molten salt include cold molten salts which exist singly as a liquid, cold molten salts which are changed into a liquid by being blended with an electrolyte and cold molten salts which are changed into a liquid by being dissolved in an organic solvent. The melting point of the cold molten salt to be used for non-aqueous electrolyte batteries is generally 25° C. or less. The organic cation generally has a quaternary ammonium skeleton.

The polymer solid electrolyte is prepared by dissolving an electrolyte in a polymer material and by solidifying the polymer material.

The inorganic solid electrolyte is a solid material having lithium ion conductivity.

5) Separator

The separator is a member that affords a space between the positive electrode and the negative electrode. Examples of the separator material include porous films containing polyethylene, polypropylene, cellulose or polyvinylidene fluoride (PVdF) and nonwoven fabric made of a synthetic resin. The porous film is preferably made of polyethylene or polypropylene. Such a porous film can be melted at a fixed temperature to cut off current, making it possible to improve the safety of the battery.

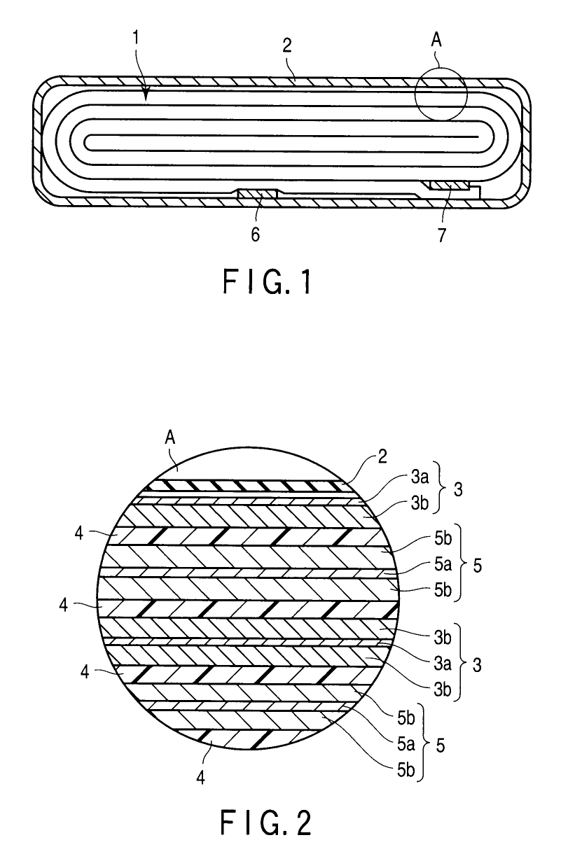

Next, the non-aqueous electrolyte battery according to the embodiment (for example, a flat type non-aqueous electrolyte battery comprising an outer case made of a laminate film) will be explained in more detail with reference to FIGS. 1 and 2. FIG. 1 is a sectional view of a thin type non-aqueous electrolyte battery and FIG. 2 is an enlarged sectional view of the A part of FIG. 1. Each drawing is a typical view for explaining the invention and for promoting the understanding thereof. Though there are parts different from an actual battery in shape, dimension and ratio, these structural designs may be properly changed taking the following explanations and known technologies into consideration.

A flattened wound electrode group 1 is housed in a bag-like outer case 2 made of a laminate film obtained by interposing an aluminum foil between two resin layers. The flattened wound electrode group 1 is formed by spirally wounding a laminate obtained by laminating a negative electrode 3, a separator 4, a positive electrode 5 and a separator 4 in this order from the outside and by press-molding the coiled laminate. The outermost negative electrode 3 has a structure in which, as shown in FIG. 2, a negative electrode layer 3b is formed on one of the inside surfaces of a negative electrode current collector 3a. Other negative electrodes 3 each have a structure in which a negative electrode layer 3b is formed on each surface of the negative electrode current collector 3a. The negative electrode layer 3b contains, as an active material, the above-described monoclinic β-type titanium composite oxide. The positive electrode 5 has a structure comprising a positive electrode layer 5b on each side of a positive electrode current collector 5a.

In the vicinity of the outer peripheral end of the flattened wound electrode group 1, a negative electrode terminal 6 is connected to the negative electrode current collector 3a of the outermost negative electrode 3 and a positive electrode terminal 7 is connected to the positive electrode current collector 5a of the inside positive electrode 5. These negative electrode terminal 6 and positive electrode terminal 7 are externally extended from an opening part of the bag-like outer case 2. A liquid non-aqueous electrolyte is, for example, injected from the opening part of the bag-like outer case 2. The opening part of the bag-like outer case 2 is closed by heat sealing with the negative electrode terminal 6 and positive electrode terminal 7 caught in the opening part to thereby perfectly seal the flattened wound electrode group 1 and liquid non-aqueous electrolyte.

The negative electrode terminal is made of, for example, a material having electric stability and conductivity in a potential range of 0.5 V or more and 3.0 V or less with respect to a lithium ion metal. Examples of the material for the negative electrode terminal include aluminum and aluminum alloys containing elements such as Mg, Ti, Zn, Mn, Fe, Cu or Si. The negative electrode terminal is preferably made of the same material as the negative electrode current collector to reduce the contact resistance with the negative electrode current collector.

The positive electrode terminal is made of, for example, a material having electric stability and conductivity in a potential range of 3.0 V or more and 5.0 V or less with respect to a lithium ion metal. Specific examples of the material for the positive electrode terminal include aluminum and aluminum alloys containing elements such as Mg, Zn, Mn, Fe, Cu or Si. The positive electrode terminal is preferably made of the same material as the positive electrode current collector to reduce the contact resistance with the positive electrode current collector.

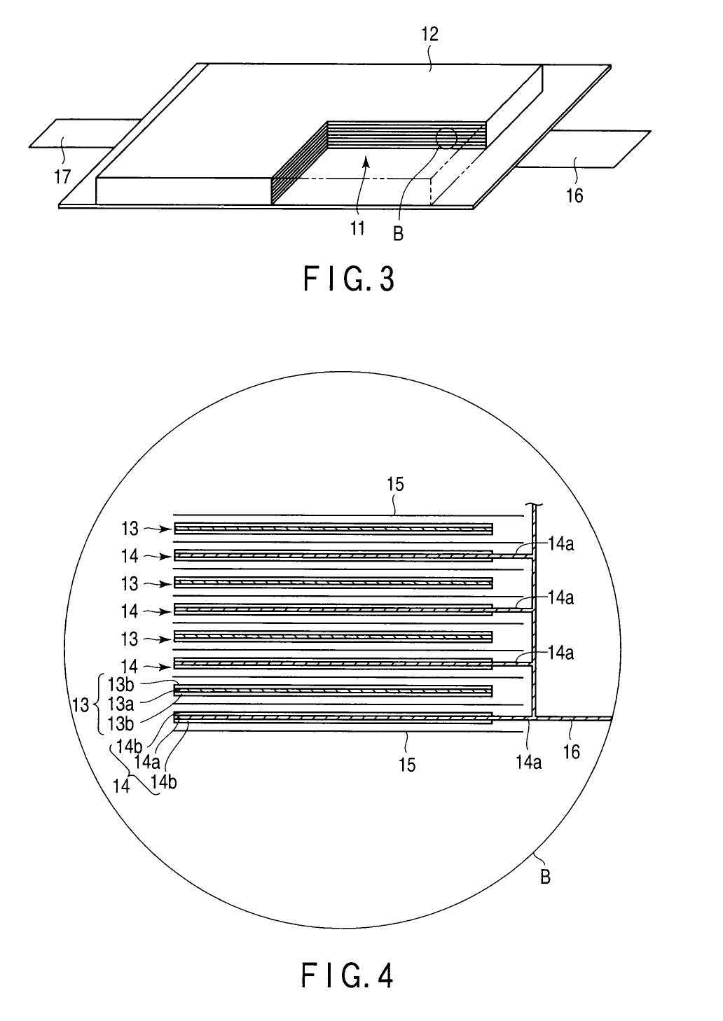

The structure of the non-aqueous electrolyte battery according to the embodiment is not limited to the structure shown in FIGS. 1 and 2 but may be those shown in FIGS. 3 and 4. FIG. 3 is a partially broken perspective view typically showing another flat type non-aqueous electrolyte secondary battery according to the embodiment and FIG. 4 is an enlarged sectional view of the B part of FIG. 3.

A laminate type electrode group 11 is housed in an outer case 12 made of a laminate film obtained by interposing a metal layer between two resin films. The laminate type electrode group 11 has, as shown in FIG. 4, a structure in which a positive electrode 13 and a negative electrode 14 are alternately laminated with a separator 15 interposed therebetween. There are plural positive electrodes 13 which each comprise a current collector 13a and a positive electrode active material-containing layer 13b supported on each surface of the current collector 13a. There are plural negative electrodes 14 which each comprise a current collector 14a and a negative electrode active material-containing layer 14b supported on each surface of the current collector 14a. One end of the current collector 14a of each negative electrode 14 is projected from the positive electrode 13. The projected current collector 14a is electrically connected to a band-like negative electrode terminal 16. The tip of the band-like negative electrode terminal 16 is drawn externally from the package member 11. Also, on the side positioned opposite to the projected side of the current collector 14a, though not shown, the current collector 13a of the positive electrode 13 is projected from the negative electrode 14. The current collector 13a projected from the negative electrode 14 is electrically connected to a band-like positive electrode terminal 17. The tip of the band-like positive electrode terminal 17 is positioned opposite to the negative electrode terminal 16 and drawn externally from the side of the package member 11.

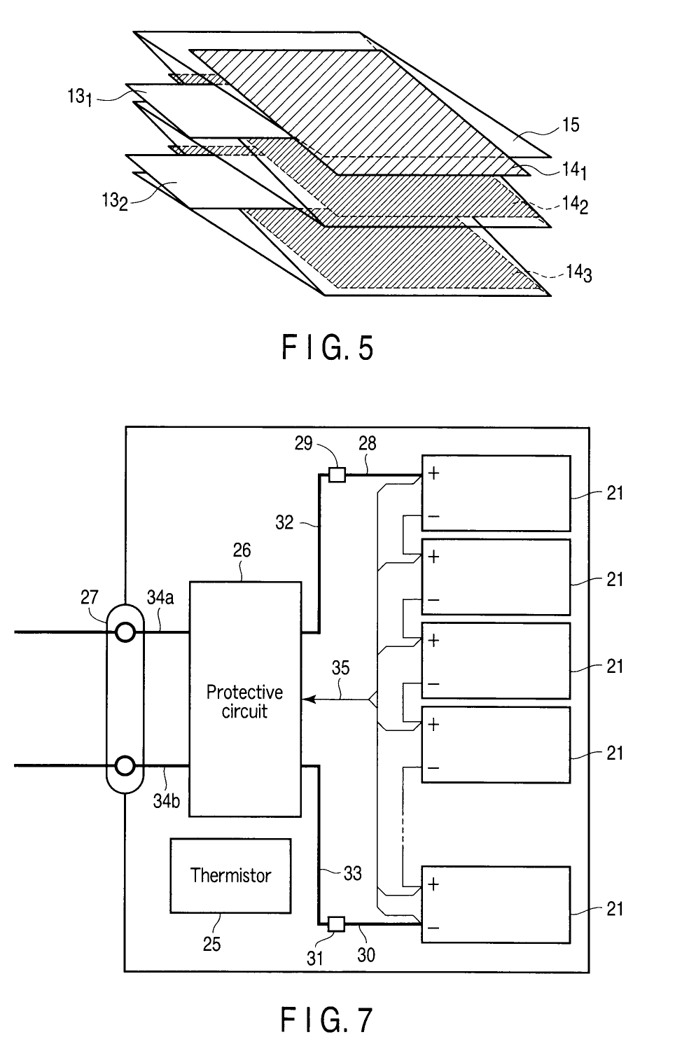

Examples of the structure of the electrode group include a flattened wound structure as shown in FIGS. 1 and 2 and a laminate structure as shown in FIGS. 3 and 4. The electrode group preferably has a laminate structure because this structure provides not only excellent input/output characteristics but also high safety and reliability. Also, to attain an excellent large-current performance over a long period of use, the electrode group containing a positive electrode and a negative electrode preferably has a laminate structure in which, as shown in FIG. 5, the separator is zigzag-folded upon use. The band-like separator 15 is folded in a zigzag shape. A negative electrode 14₁ having a strip form is laminated on the uppermost layer of the zigzag-folded separator 15. A strip-like positive electrode 13₁, a strip-like negative electrode 14₂, a strip-like positive electrode 13₂ and a strip-like negative electrode 14₃ are inserted in this order from above on a part where the separators 15 are overlapped on each other. An electrode group having a laminate structure is obtained by disposing the positive electrode 13 and the negative electrode 14 alternately between the zigzag-folded separators 15 in this manner.

When the separator is zigzag-folded, three sides of each of the positive electrode and negative electrode are directly in contact with the non-aqueous electrolyte not through the separator. For this reason, the non-aqueous electrolyte is smoothly moved from the positive electrode to the negative electrode. As a result, even if the non-aqueous electrolyte is used for a long time and consumed on the surfaces of the positive electrode and negative electrode, the non-aqueous electrolyte is smoothly supplied, making it possible to attain excellent large-current characteristics (input/output characteristics) for a long period of time. When a bag-like structure is adopted as the separator, only one side of each of the positive electrode and negative electrode disposed in the bag is in direct contact with the non-aqueous electrolyte, even though the same laminate structure is used. For this reason, it is difficult to supply the non-aqueous electrolyte to the positive electrode and negative electrode smoothly. As a result, when the non-aqueous electrolyte is used for a long time and consumed on the surfaces of the positive electrode and negative electrode, the non-aqueous electrolyte is not smoothly supplied, so that the large-current characteristics (input/output characteristics) are gradually deteriorated along with increase in the frequency of use. It is therefore preferable that the electrode group comprising the positive electrode and negative electrode has a laminate structure and the separator that spatially separates the positive electrode from the negative electrode be disposed in a zigzag shape.

Next, a battery pack according to an embodiment will be explained in detail.

In general, according to another embodiment, a battery pack comprises two or more of the above non-aqueous electrolyte batteries (unit cells), the unit cells being electrically connected each other in series, in parallel or in series and parallel.

The rated capacity of the unit cell is preferably 1 Ah or more and 100 Ah or less and more preferably 3 Ah or more and 50 Ah or less. Moreover, the rated capacity of the unit cell is preferably 3 Ah or more and 15 Ah or less for hybrid vehicles and 15 Ah or more and 50 Ah or less for electric vehicles or uninterruptible power supplies (UPS). Here, the rated capacity means the capacity of the unit cell when the unit cell is discharged at a rate of 0.2 C.

The number of unit cells is at least 2, preferably 5 or more and 500 or less, more preferably 5 or more and 300 or less. The number of unit cells is preferably 5 or more and 300 or less when these unit cells are applied to hybrid vehicles or electric vehicles and 5 or more and 1000 or less when these unit cells are applied to UPSs. Also, these unit cells are preferably connected in series to obtain a high voltage when they are applied to car batteries.

The aforementioned unit cells are suitable to produce a battery module and the battery pack according to the embodiment of the present invention is superior in resistance to overcharging and in cycle characteristics.

Specifically, the battery packs differ in battery capacity and battery resistance depending on individual difference between batteries. Also, the life of the battery is reduced if the potential to which the positive electrode is exposed is increased. The battery pack according to the embodiment is obtained by combining non-aqueous electrolyte batteries in which the absolute value of the gradient of the potential of the negative electrode can be made larger than that of the positive electrode in the course of the process of fully charging the battery when drawing the OCP curve of the potentials of the positive electrode and negative electrode. This ensures that the potential of the positive electrode is scarcely raised and also, the performance of the battery is scarcely deteriorated even if a part of the unit cells is overcharged. For this reason, the battery pack can be remarkably suppressed in the deterioration of performance.

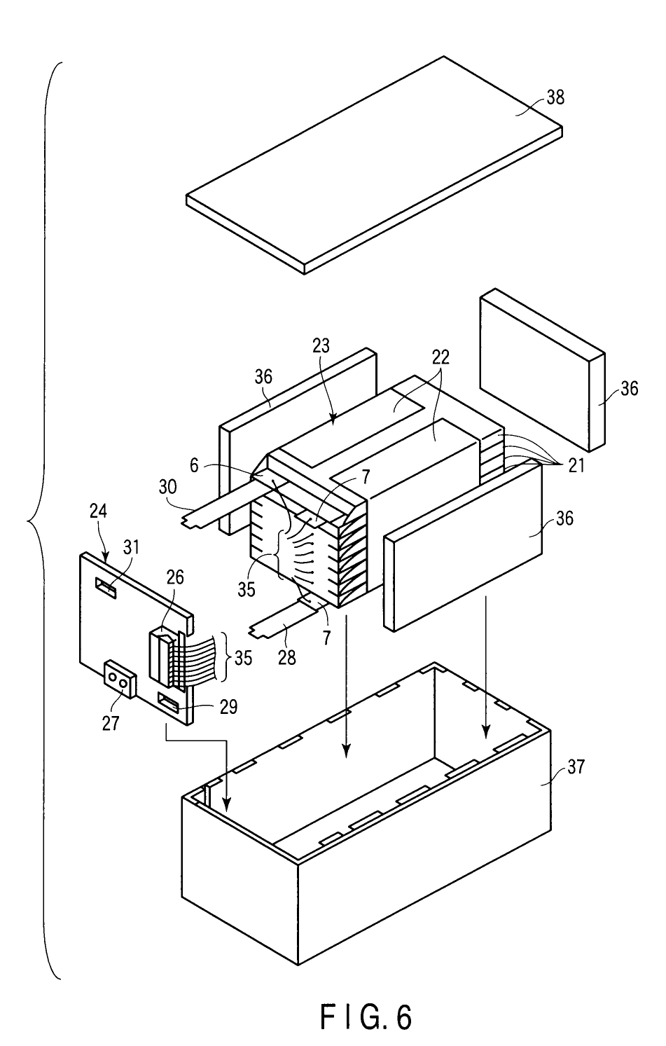

The battery pack according to this embodiment will be explained in detail with reference to FIGS. 6 and 7. As the unit cell, a flat type non-aqueous electrolyte battery shown in FIG. 1 is used.

Plural unit cells 21 are laminated such that the negative electrode terminals 6 and positive electrode terminals 7 extended externally are arranged in the same direction and then fastened with an adhesive tape 22 to thereby constitute a battery module 23. These unit cells 21 are electrically connected with each other in series as shown in FIG. 6.

A printed wiring board 24 is disposed opposite to the side surface of the unit cell 21 from which the negative electrode terminal 6 and positive electrode terminal 7 are extended. As shown in FIG. 7, a thermistor 25, a protective circuit 26 and a conducting terminal 27 that conducts electricity to external devices are mounted on the printed wiring board 24. In this case, an insulting plate (not shown) is attached to the printed wiring board 24 facing the battery module 23 to avoid unnecessary connections with the wiring of the battery module 23.

A positive electrode side lead 28 is connected to the positive electrode terminal 7 positioned at the lowermost layer of the battery module 23 and the tip of the lead 28 is inserted into and electrically connected to a positive electrode side connector 29 of the printed wiring board 24. A negative electrode side lead 30 is connected to the negative electrode terminal 6 positioned at the uppermost layer of the battery module 23 and the tip of the lead 30 is inserted into and electrically connected to a negative electrode side connector 31 of the printed wiring board 24. These connectors 29 and 31 are connected to the protective circuit 26 through wirings 32 and 33 formed on the printed wiring board 24.

The thermistor 25 is used to detect the temperature of the unit cell 21 and the detected signals are transmitted to the protective circuit 26. The protective circuit 26 can shut off a plus side wiring 34a and a minus side wiring 34b between the protective circuit 26 and the conducting terminal 27 used to conduct electricity to external devices, under a predetermined condition. The predetermined condition means, for example, the case where the temperature detected by the thermistor 25 exceeds a predetermined temperature. Also, the predetermined condition means the case of detecting overcharge, overdischarge, over-current and the like. This over-current or the like is detected with respect to individual unit cells 21 and all of the unit cells 21. When the over-current and the like of individual unit cells 21 are detected, either the voltage of the battery may be detected or the potential of the positive electrode or negative electrode may be detected. In the latter case, a lithium electrode to be used as the reference electrode is inserted into each unit cell 21. In the case of FIGS. 6 and 7, a wiring 35 that detects voltage is connected to each unit cell 21 and the detected signals are transmitted to the protective circuit 26 through these wirings 35.

A protective sheet 36 made of rubber or resin is disposed on each of the three sides of the battery module 23 excluding the side from which the positive electrode terminal 7 and negative electrode terminal 6 are projected.

The battery module 23 is housed in a receiving container 37 together with each protective sheet 36 and the printed wiring board 24. Specifically, the protective sheet 36 is disposed on each of the both inside surfaces of the long side and one inside surface of the short side of the receiving container 37, and the printed wiring board 24 is disposed on the opposite inside surface of the short side of the receiving container 37. The battery module 23 is disposed in a space enclosed with the protective sheets 36 and printed wiring board 24. The lid 38 is attached to the upper surface of the receiving container 37.

The battery pack of the embodiment is superior in the control of the positive or negative electrode potential by detecting the voltage of the battery and is therefore particularly suitable to the case where the protective circuit detects only the voltage of the battery.

In this case, a heat shrinkable tape may be used in place of the adhesive tape 22 to secure the battery module 23. In this case, a protective sheet is disposed on each side of the battery module and the heat shrinkable tape is wound around the battery. Then, the heat shrinkable tape is thermally shrunk to fasten the battery module.

Though FIGS. 6 and 7 show the structure in which the unit cells 21 are connected in series, the unit cells 21 may be connected in parallel or in series-parallel assemblies to increase the capacity of the battery. The assembled battery packs may be further connected in series or in parallel.

Also, other aspects of the battery pack may be suitably changed according to the application.

The battery pack of this embodiment is preferably used in applications in high-temperature environments. Specific examples of these applications include vehicle applications such as two- to four-wheel hybrid electric vehicles, two- to four-wheel electric vehicles and electric bicycles and emergency applications of electronic devices. The battery pack can be mounted on a variety of vehicles.

When the battery pack is used in vehicle applications, the battery pack is required for cycle characteristics under an environment of a temperature as high as about 60° C. When the battery pack is used in emergency applications of electronic devices, the battery pack is required for cycle characteristics under an environment of a temperature as high as about 45° C.

A vehicle according to an embodiment comprises the aforementioned battery pack. Here, examples of the vehicle include two- to four-wheel hybrid electric vehicles, two- to four-wheel electric vehicles and electric bicycles.

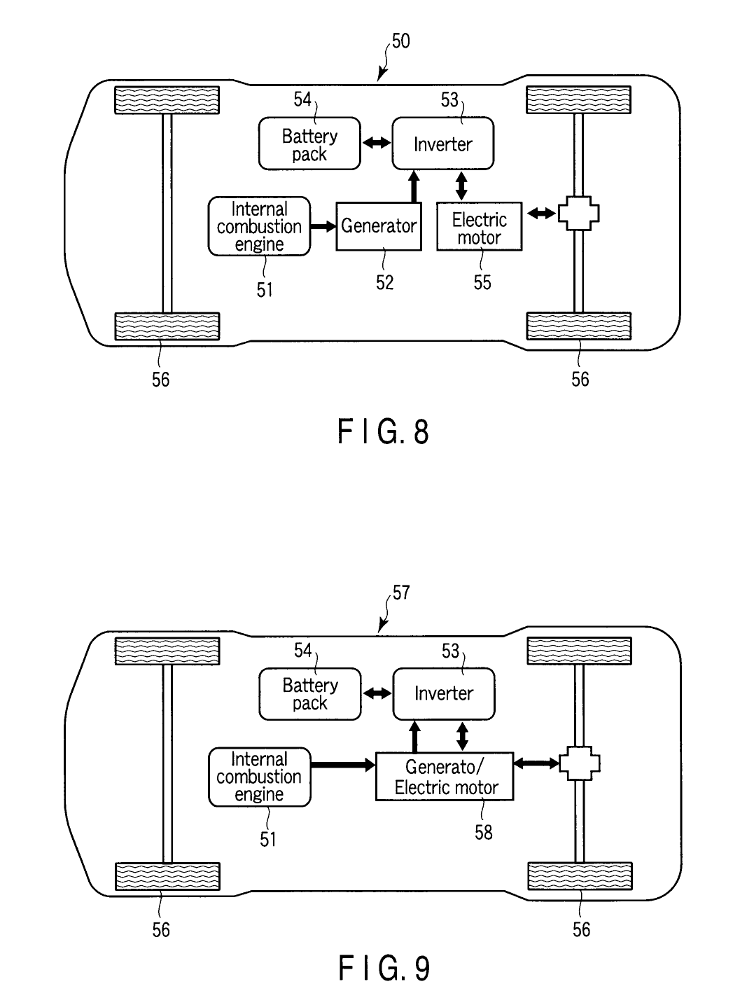

FIGS. 8 to 10 show a hybrid type vehicle utilizing a combination of an internal combustion engine and a battery drive electric motor as the running power source. As the driving force of a vehicle, a power source enabling a wide range of rotations and torque according to running conditions is required. Generally, internal combustion engines are limited in torque/number of rotations at which the ideal energy efficiency is obtained, and therefore the energy efficiency is reduced in the operating conditions other than the above specified condition. In the case of hybrid type vehicles, the internal combustion engine is operated under the optimum condition to generate power and the wheels are driven by a highly efficient electric motor. Also, a vehicle of this type is driven by the motive powers of an internal combustion engine and electric motor. The energy efficiency of the whole vehicle can be thereby improved. Also, the vehicle's kinetic energy is recovered as electric power when the vehicle is decelerated. For this reason, the mileage per unit fuel can be increased more significantly than a usual vehicle driven only by an internal combustion engine.

Hybrid vehicles can be roughly classified into three categories based on the combination of internal combustion engine and electric motor.

FIG. 8 shows a hybrid vehicle 50, which is generally called a series hybrid vehicle. The entire motive force of an internal combustion engine 51 is converted into electric power by a generator 52 and this electric power is stored in a battery pack 54 through an inverter 53. As the battery pack 54, one having the above structure is used. The electric power of the battery pack 54 is supplied to an electric motor 55 through the inverter 53 and a wheel 56 is driven by the electric motor 55. This is a system using a generator in an electric vehicle. The internal combustion engine can be operated in a highly efficient condition and the power can be recovered. On the other hand, the wheel can be driven only by an electric motor and a high-output electric motor is therefore required. Also, as to the battery pack, one having a relatively large capacity is required. Preferably, the rated capacity of the battery pack is 5 to 50 Ah and more preferably 10 to 20 Ah. Here, the rated capacity means a capacity obtained when discharged at the rate of 0.2 C.

FIG. 9 shows a hybrid vehicle 57 known as a parallel hybrid vehicle. The symbol 58 shows an electric motor doubling as a generator. The internal combustion engine 51 mainly drives the wheel 56, and a part of the motive force is sometimes converted into electric power by the generator 58 and the battery pack 54 is charged by the electric power. When the vehicle is started or accelerated, accompanied by an increase in load, the motive force is supplemented by the electric motor 58. This system is based on a usual vehicle, the internal combustion engine 51 of which is reduced in load variation, to thereby obtain high efficiency and also ensure power recovery. Because the wheel 56 is driven mainly by the internal combustion engine 51, the output of the electric motor 58 can be arbitrarily determined according to the ratio of the aid to the drive force. The system can be constituted even using a relatively small electric motor 58 and a battery pack 54 having a relatively low capacity. The rated capacity of the battery pack is 1 to 20 Ah and more preferably 5 to 10 Ah.

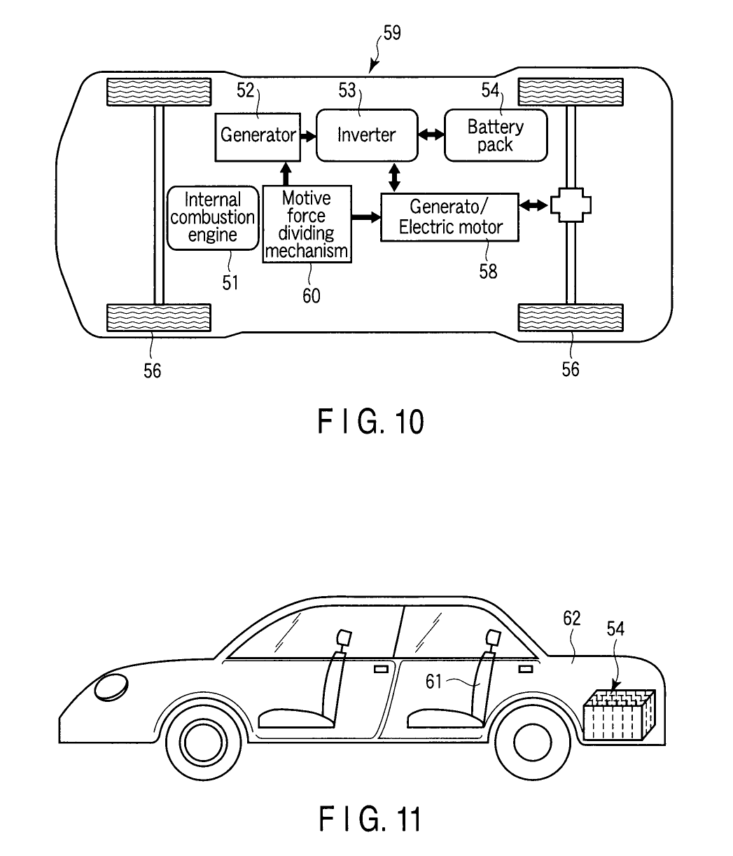

FIG. 10 shows a hybrid vehicle 59 known as a series-parallel hybrid vehicle. This is a system comprising a combination of series and parallel assemblies. A motive force dividing mechanism 60 divides the output of the internal combustion engine 51 into a generating use and a wheel-driving use. The engine load is more finely controlled than in the case of a parallel system, making it possible to improve energy efficiency.

The rated capacity of the battery pack is preferably 1 to 20 Ah and more preferably 5 to 10 Ah.

The battery pack according to the embodiment is suitable for use in series/parallel system hybrid vehicles.

The battery pack 54 is preferably disposed in a place where it is scarcely affected by the influence of variations in atmospheric temperature or impact of collisions and the like. In a sedan-type vehicle as shown in, for example, FIG. 11, the battery pack 54 may be disposed in a trunk room 62 at the rear of a back seat 61. The battery pack 54 may be disposed under or behind the seat 61. In the case where the battery has a large weight, it is preferable to dispose the battery pack under the seat or floor to lower the center of gravity of the whole vehicle.

An electric vehicle (EV) runs on the energy stored in the battery pack. The battery pack is charged by supplying electric power from the outside of the vehicle. For this reason, the electric vehicle can utilize electric energy generated efficiently by other generating equipment. The kinetic energy of the vehicle is recovered as electric power when the vehicle is decelerated. This ensures high energy efficiency during running. Because the electric vehicle emits no gas containing carbon dioxide, it is a clean vehicle. On the other hand, because the motive force when the vehicle is run is produced only by an electric motor, an electric motor having a high output is required. In general, it is necessary to store the energy required for one run in the battery pack by one charge prior to running. For this reason, a battery having a very large capacity is required. The rated capacity of the battery pack is preferably 100 to 500 Ah and more preferably 200 to 400 Ah.

The battery packs are preferably disposed at a low position and also a position not far from the center of gravity of the vehicle in such a manner that they are spread over under the floor because the ratio of the weight of these batteries to the weight of the vehicle is large. In order to charge a large amount of electricity corresponding to one run in a short time, a charger and a charging cable having a large capacity are required. Therefore, the electric vehicle desirably comprises a charge connector to connect the charger and charging cable. A non-contact system charging connector utilizing electromagnetic coupling may be used though a usual electric contact system connector may also be used as the charging connector.

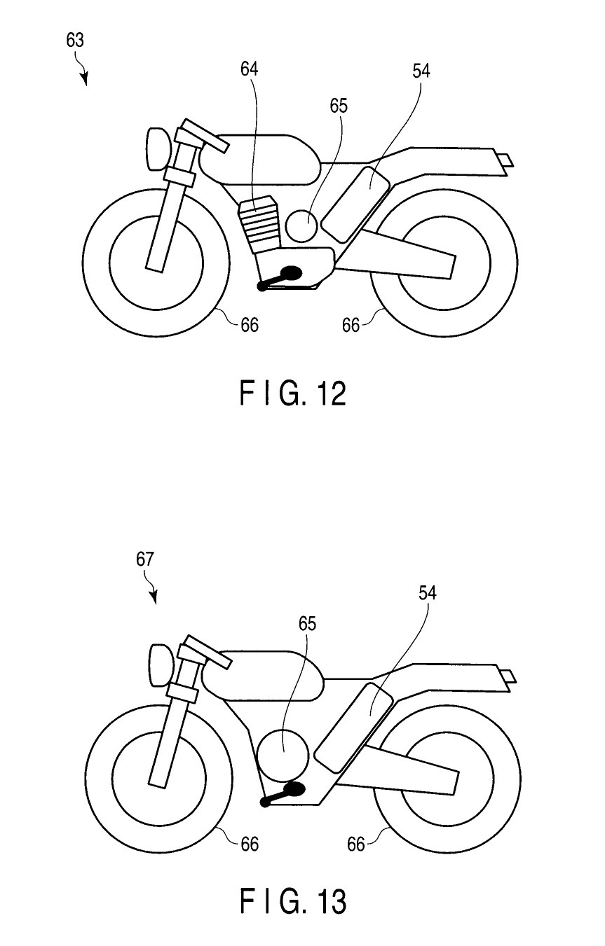

FIG. 12 shows an example of a hybrid motorcycle 63. Even in the case of a two-wheel vehicle, a hybrid motorcycle can be constituted which comprises an internal combustion engine 64, an electric motor 65 and a battery pack 54 in the same manner as the above hybrid vehicle and has a high energy efficiency. The internal combustion engine 64 primarily drives a wheel 66 and the battery pack 54 is sometimes charged by a part of the motive force. When the vehicle is started or accelerated, accompanied by an increase in load, the drive force is supplemented by the electric motor 65. Because the wheel 66 is driven mainly by the internal combustion engine 64, the output of the electric motor 65 can be arbitrarily determined according to the ratio of the aid to the drive force. The system can be constituted even using a relatively small electric motor 65 and a battery pack 54 having a relatively low capacity. The rated capacity of the battery pack is 1 to 20 Ah and preferably 3 to 10 Ah.

FIG. 13 shows an example of an electric motorcycle 67. The electric motorcycle 67 is run by the energy stored in the battery pack 54. The battery pack 54 is charged with supply of electric power from the outside. Because the motive force when the vehicle is run is produced only by the electric motor 65, an electric motor 65 having a high output is required. In general, it is necessary to store the energy required for one run, in the battery pack by one charge prior to running. For this reason, a battery having a relatively large capacity is required. The rated capacity of the battery pack is preferably 10 to 50 Ah and more preferably 15 to 30 Ah.

The present invention will be explained in more detail by way of examples. However, the present invention is not limited to the following examples within the scope of the present invention.

### Example 1

### Production of a Positive Electrode

A lithium-nickel composite oxide powder which was represented by LiNi_{0.82}Co_{0.15}Al_{0.03}O₂ and had a layer rock salt type crystal structure was prepared as a positive electrode active material. Ninety percent by weight of the positive electrode active material, and 5% by weight of acetylene black which were used as conductive agents and 5% by weight of polyvinylidene fluoride (PVdF) were added into N-methylpyrrolidone (NMP) and mixed to prepare a slurry. The slurry was applied to one surface of a current collector made of an aluminum foil having a thickness of 15 μm and an average crystal particle diameter of 30 μm and then dried, followed by pressing to produce a positive electrode comprising a positive electrode layer having a density of 3.1 g/cm³. The amount of the positive electrode layer to be applied at this time is shown in Table 1 below.

### <Production of a Negative Electrode>

A so-called TiO₂ (B) powder, that is, a monoclinic β-type titanium composite oxide having an average primary particle diameter of about 0.1 μm, a secondary particle diameter of about 10 μm and a BET specific surface area of 22 m²/g was prepared as a negative electrode active material. Eighty percent by weight of the negative electrode active material, and 10% by weight of acetylene black which were used as conductive agents and 10% by weight of polyvinylidene fluoride (PVdF) were added in N-methylpyrrolidone (NMP) and mixed to prepare a slurry. The slurry was applied to one surface of a current collector made of an aluminum foil having a thickness of 15 μm and an average crystal particle diameter of 30 μm such that the coating amount was 50 g/m² and then dried, followed by pressing to produce a negative electrode comprising a negative electrode layer having a density of 1.6 g/cm³.

### <Preparation of a Liquid Non-Aqueous Electrolyte>

1 M of LiPF₆ used as an electrolyte was dissolved in a mixed solvent of propylene carbonate (PC) and diethyl carbonate (DEC) (ratio by volume: 1:2) to prepare a liquid non-aqueous electrolyte (non-aqueous electrolyte solution).

### <Production of a Glass Cell>

The obtained positive electrode and negative electrode were respectively cut into a size of 20 mm×20 mm. The cut positive and negative electrodes were disposed such that the positive electrode layer and the negative electrode layer face each other. A 25 μm thick polyethylene porous film was interposed between these electrodes and a lithium electrode was used as a reference electrode to manufacture an electrode group. This electrode group was housed in a glass cell and the above liquid non-aqueous electrolyte was filled in the glass cell in an argon atmosphere to fabricate a triple-pole type glass cell (non-aqueous electrolyte secondary battery).

A constant current-constant voltage charge operation was performed to charge the obtained glass cell for 10 hours under the condition of a rated charge voltage of 3.0 V and 0.2 C current at 25° C. In succession, the glass cell was discharged in the same environment under the condition of a discharge terminal voltage of 1.0 V and 0.2 C current. This operation was repeated three times to stabilize the condition, thereby preparing a battery for evaluation.

The battery for evaluation was charged under 0.1 C to charge 5% of the electrode capacity and then allowed to stand for 6 hours to measure an open circuit potential. These operations were carried out in an environment of a temperature of 25° C. This operation was repeated in the following manner. With respect to the battery put in a discharged state, this operation was repeated 19 times in increments of 5% until the capacity of the battery reached 95% and then, repeated 5 times in increments of 1% until the capacity of the battery reached 100% from 95%. Open circuit potential (OCP) curves of both the positive electrode and negative electrode were obtained by these operations. In this case, the open circuit potential (OCP) was measured in increments of 1% of the capacity of the electrode in the last stage of charging in the course of the process of fully charging the battery.

The relation between these potentials was found as to whether the absolute value of the gradient of the potential of the negative electrode was larger or smaller than that of the positive electrode. Wherein each of the gradients of a potential of the negative and positive electrodes is found from variations in potential which come at the state of full charge on an open-circuit potential curve drawn from each potentials of the positive electrode and the negative electrode under the aforementioned condition. The results are shown in Table 1. The potential of the negative electrode, when the battery is the state of full charge, is also shown in Table 1.

### Examples 2 to 6 and Comparative Examples 1 to 3

Triple pole type glass cells (non-aqueous electrolyte secondary battery) were fabricated in the same manner as in Example 1 except that the coating amount of the positive electrode layer was changed to the values shown in Table 1. The relation between these potentials was found as to whether the absolute value of the gradient of the potential of the negative electrode was larger or smaller than that of the positive electrode. Wherein each of the gradients of a potential of the negative and positive electrodes is found from variations in potential which come at the state of full charge on an open-circuit potential curve drawn from each potentials of the positive electrode and the negative electrode. Also, the negative electrode potential of the glass cell in the state of full charge was found. The results are shown in Table 1 below.

These triple-pole type glass cells (non-aqueous electrolyte secondary battery) obtained in Examples 1 to 6 and Comparative Examples 1 to 3 were respectively subjected to an overcharge cycle test in which a constant current-constant voltage charge operation (1 C, 3.2 V and 3 hours) and a constant current discharge operation (0.5 C, 1 V) performed in an environment of 25° C. were repeated 100 times. The ratio (%) of the discharge capacity after 100 cycles to the first discharge capacity in the overcharge cycle test is shown in Table 1 below.

TABLE 1

| | | Relation between negative | | |
|---|---|---|---|---|
| | | and positive electrode | | |
| | | potentials as to whether | | |
| | | the absolute value of | | |
| | Coating amount | gradient of potential of | | |
| | of positive | negative electrode is | Negative electrode | Overcharge cycle |
| | electrode layer | larger or smaller than | potential | characteristics |
| | [g/m²] | that of positive electrode | [V vs Li/Li⁺] | [%] |
| Comparative | 40.0 | The former is smaller | 1.52 | <50 |
| Example 1 | | | | |
| Comparative | 42.5 | The former is smaller | 1.51 | <50 |
| Example 2 | | | | |
| Comparative | 45.0 | The former is smaller | 1.50 | <50 |
| Example 3 | | | | |
| Example 1 | 47.5 | The former is larger | 1.48 | 55 |
| Example 2 | 50.0 | The former is larger | 1.45 | 78 |
| Example 3 | 52.5 | The former is larger | 1.41 | 90 |
| Example 4 | 55.0 | The former is larger | 1.30 | 90 |
| Example 5 | 57.5 | The former is larger | 1.15 | 92 |
| Example 6 | 60.0 | The former is larger | 1.10 | 95 |

### Examples 11 to 16, Comparative Examples 11 to 13

Triple pole type glass cells (non-aqueous electrolyte secondary batteries) were fabricated in the same manner as in Example 1 except that a lithium-nickel composite oxide powder which was represented by LiNi_{0.6}CO_{0.2}Mn_{0.2}O₂ and had a layer rock salt type crystal structure was used as the positive electrode active material and the coating amount of the positive electrode layer was altered to those shown in Table 2 below.

With regard to each triple-pole glass cell (non-aqueous electrolyte secondary battery) obtained in Examples 11 to 16 and Comparative Examples 11 to 13, the relation between the negative electrode and positive electrode potentials was found as to whether the absolute value of the gradient of the potential of the negative electrode was larger or smaller than that of the positive electrode. Wherein each of the gradients of a potential of the negative and positive electrodes is found from variations in potential which come at the state of full charge on an open-circuit potential curve drawn from each potentials of the positive electrode and the negative electrode. Also, the negative electrode potential of the glass cell in the state of full charge was found. The results are shown in Table 2 below.

Each glass cell was subjected to an overcharge cycle test in which a constant current-constant voltage charge operation (1 C, 3.2 V, 3 hours) and a constant current discharge operation (0.5 C, 1 V) performed in an environment of 25° C. were repeated 100 times. The ratio (%) of the discharge capacity after 100 cycles to the first discharge capacity in the overcharge cycle test is shown in Table 2 below.

TABLE 2

| | | Relation between negative | | |
|---|---|---|---|---|
| | | and positive electrode | | |
| | | potentials as to whether | | |
| | | the absolute value of | | |
| | Coating amount | gradient of potential of | | |
| | of positive | negative electrode is | Negative electrode | Overcharge cycle |
| | electrode layer | larger or smaller than | potential | characteristics |
| | [g/m²] | that of positive electrode | [V vs Li/Li⁺] | [%] |
| Comparative | 45.5 | The former is smaller | 1.52 | <50 |
| Example 11 | | | | |
| Comparative | 48.5 | The former is smaller | 1.51 | <50 |
| Example 12 | | | | |
| Comparative | 51.5 | The former is smaller | 1.50 | <50 |
| Example 13 | | | | |
| Example 11 | 54.0 | The former is larger | 1.48 | 65 |
| Example 12 | 57.5 | The former is larger | 1.45 | 87 |
| Example 13 | 60.0 | The former is larger | 1.40 | 92 |
| Example 14 | 62.5 | The former is larger | 1.28 | 92 |
| Example 15 | 66.5 | The former is larger | 1.14 | 93 |
| Example 16 | 68.5 | The former is larger | 1.09 | 96 |

As is clear from the above Tables 1 and 2, it is understood that each non-aqueous electrolyte battery obtained in Examples 1 to 6 and 11 to 16, in which the absolute value of the gradient of the potential of the negative electrode is larger than that of the positive electrode, wherein each of the gradients of a potential of the negative and positive electrodes is found from variations in potential which come at the state of full charge on an open-circuit potential curve drawn from each potentials of the positive electrode and the negative electrode, has more excellent overcharge cycle characteristics than each non-aqueous electrolyte battery obtained in Comparative Examples 1 to 3 and 11 to 13, in which the absolute value of the gradient of the potential of the negative electrode is the same as or smaller than that of the positive electrode in the course of the process of fully charging the battery.

It is also understood that each non-aqueous electrolyte battery obtained in Examples 1 to 6 and 11 to 16, in which the absolute value of the gradient of the potential of the negative electrode is larger than that of the positive electrode, wherein each of the gradients of a potential of the negative and positive electrodes is found from variations in potential which come at the state of full charge on an open-circuit potential curve drawn from each potentials of the positive electrode and the negative electrode, and at the same time, the negative electrode potential at which the negative electrode is the state of full charge is 1.48 V vs Li/Li⁺ or less, has more excellent overcharge cycle characteristics. Moreover, it is understood that each non-aqueous electrolyte battery obtained in Examples 3 to 6 and 13 to 16, in which the negative electrode potential at which the negative electrode is the state of full charge is 1.40 V vs Li/Li⁺ or less, has further excellent overcharge cycle characteristics.

What is claimed is:

1. A non-aqueous electrolyte battery comprising:
an outer case;
a positive electrode housed in the outer case and containing a positive electrode active material;
a negative electrode housed in the outer case and containing a monoclinic crystal β-type titanium composite oxide; and
a non-aqueous electrolyte filled in the outer case,
wherein an absolute value of a gradient of a potential of the negative electrode is larger than that of the positive electrode, here each of the gradients of a potential of the negative and positive electrodes is found from variations in potential which come at the state of full charge on an open-circuit potential curve drawn from potentials of the positive electrode and the negative electrode.

2. The battery of claim 1, wherein the open-circuit potential of the negative electrode at which the negative electrode is the state of full charge, is 1.48 V vs Li/Li⁺ or less.

3. The battery of claim 1, wherein the open-circuit potential of the negative electrode at which the negative electrode is the state of full charge, is 1.40 V vs Li/Li⁺ or less.

4. The battery of claim 1, wherein the positive electrode active material is a lithium transition metal composite oxide.

5. The battery of claim 4, wherein the lithium transition metal oxide has a layer structure and is represented by a compositional formula: Li_{y}M1_{z1}M2_{z2}O₂, where M1 is at least one element selected from the group consisting of Co, Ni and Mn, M2 is at least one element selected from the group consisting of Fe, Al, B, Ga and Nb, and y, z1 and z2 satisfy 0<y≦1.2, 0.98≦z1+z2≦1.2 and 0≦z2≦0.2, respectively.

6. The battery of claim 4, wherein the lithium transition metal oxide is a lithium-nickel composite oxide having a layer structure.

7. The battery of claim 1, wherein the monoclinic β-type titanium composite oxide has a crystallite diameter of 20 nm or more and 1 μm or less, the crystallite diameter being calculated from a main peak present at 2θ=48 to 49 degrees by wide-angle X-ray diffraction measurement.

8. The battery of claim 1, wherein the monoclinic β-type titanium composite oxide has an average primary particle diameter of 1 μm or less.

9. The battery of claim 1, wherein the monoclinic β-type titanium composite oxide has a specific surface area of 5 to 100 m²/g.

10. The battery of claim 1, wherein the outer case is formed from a laminate film having a thickness of 1 mm or less.

11. A battery pack comprising a plurality of the non-aqueous electrolyte batteries as claimed in claim 1, which are connected each other in series, in parallel, or in series and parallel.

12. The battery pack of claim 11, further comprising a protective circuit configured to detect a voltage of each non-aqueous electrolyte battery.

13. A vehicle comprising the battery pack as claimed in claim 11.
